(19) United States
(12) Patent Application Publication
(10) Pub. No.: US 2007/0034596 A1
(43) Pub. Date: Feb. 15, 2007

(54) Printed wiring board fabrication method, printed wiring board photomask, and program for creating a photomask

(75) Inventors: Yukihiro Ueno, Hiroshima (JP); Noboru Okabayashi, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/501,062

(22) Filed: Aug. 9, 2006

(30) Foreign Application Priority Data
Aug. 10, 2005 (JP) 2005-232053

(51) Int. Cl. H01B 13/00

(52) U.S. Cl. 216/13

(57) ABSTRACT

The present invention is configured such that a wiring pattern, formed by forming an etching resist on metal foil that has been layered on an insulating resin board and performing etching via this etching resist, is provided with a circuit pattern constituting an electronic circuit and a dummy pattern provided in the vicinity of and separated from the circuit pattern, such that side etching of the circuit pattern is suppressed by mitigating the rate at which etching advances for the circuit pattern.

### BACKGROUND OF THE INVENTION

This application claims priority under 35 U.S.C. §119(a) on Japanese Patent Application No. 2005-232053 filed in Japan on Aug. 10, 2005, the entire contents of which are hereby incorporated by reference.

The present invention relates to fabrication methods for a printed wiring board with respect to creation of a wiring pattern, photomasks for a printed wiring board, and programs for creating a photomask.

First, a conventional fabrication method for a printed wiring board will be described with reference to the drawings.

A substrate of a printed wiring board is constituted from insulating resin, and copper foil is layered on the surface of the substrate. A dry film photoresist is applied to the copper foil, a photomask is overlaid, and ultraviolet rays are irradiated, forming an etching resist. Next, a portion that is not covered by the etching resist is etched with an etching solution. Then, a wiring pattern is formed by removing the etching resist, forming a printed wiring board.

FIG. 8 is a schematic cross-sectional view of a printed wiring board that shows the state after etching. Etching advances not only in a direction perpendicular to a substrate 110, but also in a direction horizontal relative to the substrate 110. That is, a side face of a copper foil 150 that is a portion that has been covered by an etching resist 160 is etched, producing so-called side etching. Accordingly, a somewhat small wiring pattern is formed by a pattern of the etching resist 160.

FIG. 9 is a plan view that shows the etching resist pattern and the wiring pattern that has been formed. A wiring pattern 122 that has been formed by etching is formed smaller overall than a resist pattern 132, and moreover, an end 124 is comparatively smaller than other portions. This is because the rate at which etching advances is faster for the end portion 124 than for other portions.

The rate of etching advancement changes depending on the flow, the degree of activity, the temperature, and the concentration of the etching solution. Accordingly, because the flow, the degree of activity, the temperature, and the concentration of the etching solution change depending on the manner of disposing the printed wiring board relative to the etching solution, the form of the wiring pattern, and the like, even on a single printed wiring board, the rate of etching advancement varies depending on the location. Thus, even on a single printed wiring board, an equivalently etched wiring pattern is not formed; rather, portions are produced in which etching has advanced too much.

For example, depending on the wiring pattern, there are portions in which the etching solution flows easily and portions in which the etching solution easily accumulates, and the amount of etching is comparatively greater in portions where the etching solution flows easily. Also, in portions where the etching solution easily accumulates, the concentration of the etching solution is kept high, and the degree of activity is relatively high, so there is a tendency for the amount of etching to become comparatively large. For regions on the upstream side relative to the flow of the etching solution as well, contact is made in a state with a high degree of activity of the etching solution, and so the amount of etching becomes relatively large.

Also, because the rate of etching advancement changes according to the properties of the copper foil, the direction of a crystal face, thickness, and the like even on a single printed wiring board, if the state of the copper foil varies depending on the location, the amount of etching at that location will vary.

Accordingly, various methods for solving these sorts of problems have been proposed. For example, in the technology disclosed in JP S59-116657A (Conventional Technology 1), the amount of side etching is measured by first etching on a trial basis, and the wire pattern is corrected based on this measured value.

FIG. 10 is a schematic diagram of the wiring pattern of Conventional Technology 1. In FIG. 10, the solid line indicates a resist pattern 132 that has been corrected, and the dotted line indicates a wiring pattern 122 that is formed. A large correction corresponding to the amount of side etching has been made to the resist pattern 132. Thus the Conventional Technology 1 is configured such that it is possible to form the predetermined wiring pattern 122.

However, with Conventional Technology 1, it is necessary to actually perform etching in advance, and in addition to the amount of processing increasing, the correction value needs to be measured, which is a problem for production efficiency.

Also, as disclosed in JP H4-23338A, there is also technology (Conventional Technology 2) in which adjacent wiring patterns have approximately the same form. FIG. 11 is a front view of a printed wiring board according to Conventional Technology 2.

As shown in FIG. 11, in the initial wiring pattern 122, conducting wires 123 are provided on both sides of several of a plurality of parallel pads 125, and conducting wires 123 are provided on only one side of several of the pads 125. For this sort of wiring pattern 122, correction conducting wires 181 are provided in pads 125 provided with a conducting wire 123 on only one side, same as the pads 125 adjacent thereto. Thus, because it is possible to arrange the etching state of the parallel pads 125 with the same conditions, the pads 125 are formed with equivalent forms.

However, with Conventional Technology 2, although it is possible to make the etching state equivalent between adjacent terminals, because the amount of etching is not controlled, it is not possible to control the wiring pattern to a predetermined width. Also, because there is correction in the terminal portions, the Conventional Technology 2 cannot be applied to other wiring patterns.

Also, as disclosed in JP H5-110226A, there is technology (Conventional Technology 3) in which a bent portion of the wiring pattern is made thick. FIG. 12 is a front view of a printed wiring board according to Conventional Technology 3.

As shown in FIG. 12, a bent portion 191 of the wiring pattern 122 is thickly formed. In this sort of bent portion 191 side etching advances too much compared to the straight portions of the wiring pattern 122, so the bent portion 191 is designed thicker than the width of the conducting wire 123 in the straight portions.

However, with Conventional Technology 3, because there is correction in the bent portion, the Conventional Technology 2 cannot be applied to the wiring patterns other than the bent portion, i.e. the straight portions.

Also, with above Conventional Technology 2 and 3, there is the problem that it is necessary to revise the original etching resist itself, which is troublesome.

### SUMMARY OF THE INVENTION

The present invention was made in view of these problems, and it is an object thereof to provide a printed wiring board fabrication method in which it is possible to easily control side etching in necessary portions, a photomask for a printed wiring board, and a photomask creation program.

In order to address the above problems, in the printed wiring board fabrication method according to the present invention, an etching resist is formed on metal foil that has been layered on an insulating resin board and etching is performed via the etching resist, thus forming a wiring pattern, and the wiring pattern is provided with a circuit pattern constituting an electronic circuit and a dummy pattern provided in the vicinity of and separated from the circuit pattern.

With this configuration, because the dummy pattern is formed at the same time that the circuit pattern is formed by etching, etching solution near the circuit pattern etches both the circuit pattern and the dummy pattern, so the speed at which etching advances for the circuit pattern is mitigated, and it is possible to suppress side etching of the circuit pattern. That is, by forming the dummy pattern in the vicinity of the circuit pattern, for which dimensional precision is sought, it is possible to improve the dimensional precision of the circuit pattern.

Also, by changing, for example, the size, shape or arrangement of the dummy pattern, it is possible to control the flow, degree of activity, temperature, concentration, and the like of the etching solution in the etching process, so it is possible to suitably control the form of etching to match the form of side etching of the circuit pattern.

Also, in the printed wiring board fabrication method according to the present invention, the dummy pattern is completely removed by etching.

Thus, when the printed wiring board is completed, unnecessary dummy patterns are eliminated, so mistakes in packaging do not occur. That is, when a dummy pattern remains, there is a risk that a terminal of an electronic component or the like will be disposed on a dummy pattern due to a packaging mistake, but this sort of packaging mistake does not occur.

Also, in the printed wiring board fabrication method according to the present invention, the dummy pattern is partially removed by etching.

Thus, because the dummy pattern is present in the vicinity of the circuit pattern while etching is being performed, side etching is constantly suppressed during etching, so it is possible to appropriately control etching. That is, when the present invention has been configured such that the dummy pattern is completely removed, the dummy pattern is completely removed before etching of the circuit pattern finishes, so only the circuit pattern is etched after the dummy pattern has been completely removed, and therefore side etching advances. On the other hand, when a configuration has been adopted in which the dummy pattern is partially removed and part remains, such a situation does not occur, so side etching is effectively controlled and an appropriate circuit pattern can be formed.

Also, in the printed wiring board fabrication method according to the present invention, etching conditions for the etching are modified according to the amount of etching of the dummy pattern.

Thus, it is possible to form an optimum circuit pattern. Also, because the dummy pattern is separated from the circuit pattern, it is easy to compare the resist area for the dummy pattern and the area of the dummy pattern after etching, and it is possible to change to suitable etching conditions as appropriate, in concert with the rate of etching advancement.

Also, in the printed wiring board fabrication method according to the present invention, the dummy pattern is formed on a line extended from an end of the circuit pattern.

Thus, it is possible to control the flow, degree of activity, temperature, and concentration of the etching solution in the vicinity of the end of the circuit pattern, so it is possible to control side etching in the end of the circuit pattern.

Also, in the printed wiring board fabrication method according to the present invention, the dummy pattern is formed on both sides of a line extended from the end of the circuit pattern.

Thus, it is possible to control the flow, degree of activity, temperature, and concentration of the etching solution that passes through both sides of the end of the circuit pattern, so it is possible to control side etching in the end of the circuit pattern.

Also, in the printed wiring board fabrication method according to the present invention, the circuit pattern is formed with a rectangular terminal shape.

Thus, it is possible to control side etching in the end of a rectangular terminal formed in the printed wiring board.

Also, in the printed wiring board fabrication method according to the present invention, ends of the circuit pattern are disposed in parallel, and dummy patterns are disposed in parallel corresponding to each end of a circuit pattern.

Thus, it is possible to suppress side etching for the respective ends of the parallel circuit patterns.

Also, in the printed wiring board fabrication method according to the present invention, the dummy patterns are formed and disposed lined up in a plurality of lines.

Thus, because the dummy patterns are disposed in a plurality of lines, it is possible to effectively control the flow, degree of activity, temperature, and concentration of the etching solution, so it is possible to suppress side etching in the end of the circuit pattern.

Also, in the printed wiring board fabrication method according to the present invention, the dummy patterns formed in a plurality of lines are formed and disposed with each of the plurality of lines offset relative to one another in the direction in which they are lined up.

Thus, because it is possible to control the flow of etching solution that flows between dummy patterns with better precision, it is possible to reduce the difference in the concentration of the etching solution according to the location in the end of the circuit pattern, so it is possible to reduce variation in the rate of side etching according to the location.

Also, in the printed wiring board fabrication method according to the present invention, the dummy pattern is formed in the vicinity of an angled portion of the circuit pattern.

Thus, it is possible to control the flow, degree of activity, temperature, and concentration of the etching solution in the vicinity of the angled portion of the circuit pattern (for example, an angled portion of a land on which an electronic component is mounted), so it is possible to control side etching in the angled portion.

Also, in the printed wiring board fabrication method according to the present invention, the angled portion is a bent portion of the circuit pattern.

Thus, it is possible to control the flow, degree of activity, temperature, and concentration of the etching solution in the vicinity of the bent portion of the circuit pattern (for example, a bent portion of a wiring line), so it is possible to control side etching in the bent portion.

Also, in the printed wiring board fabrication method according to the present invention, the dummy pattern has a circular, oval, rectangular, or triangular shape.

Thus, it is possible to appropriately control the flow, degree of activity, temperature, and concentration of the etching solution in the vicinity of the circuit pattern.

Also, by disposing the dummy pattern with its shape appropriately modified according to the position (position relative to the printed wiring board as a whole), shape, and the like of the circuit pattern, the amount of etching for each portion is controlled, and it is possible to create a circuit pattern that is optimum as a whole.

Also, in a photomask according to the present invention, which is a photomask for a printed wiring board for forming an etching resist that corresponds to a wiring pattern on metal foil that has been layered on an insulating resin board, the wiring pattern is provided with a circuit pattern constituting an electronic circuit and a dummy pattern provided in the vicinity of and separated from the circuit pattern.

Thus, it is possible to form a circuit pattern that constitutes an electric circuit and a dummy pattern that can suppress side etching for a printed wiring board.

Also, in a photomask creation program according to the present invention, which is a photomask creation program that creates a mask pattern of a photomask for forming a photoresist that corresponds to a wiring pattern of a printed wiring board, the wiring pattern is provided with a circuit pattern constituting an electronic circuit and a dummy pattern provided in the vicinity of and separated from the circuit pattern.

Thus, the photomask creation program can create a photomask that has a circuit pattern that constitutes an electric circuit and a dummy pattern that can suppress side etching.

### BRIEF DESCRIPTION OF THE DRAWINGS

FIG. 1 is an enlarged schematic view that shows a terminal, a dummy pattern, and a resist pattern that corresponds thereto.

FIG. 2 is a plan view that shows an example of a wiring pattern for a printed wiring board according to Embodiment 1.

FIG. 3 is a plan view that shows another example of a wiring pattern for a printed wiring board according to Embodiment 1.

FIG. 4 is a plan view that shows still another example of a wiring pattern for a printed wiring board according to Embodiment 1.

FIG. 5 is a plan view that shows still another example of a wiring pattern for a printed wiring board according to Embodiment 1.

FIG. 6 is a plan view that shows still another example of a wiring pattern for a printed wiring board according to Embodiment 1.

FIG. 7 is a plan view that shows still another example of a wiring pattern for a printed wiring board according to Embodiment 1.

FIG. 8 is a schematic cross-sectional view of a conventional printed wiring board that shows the state after etching.

FIG. 9 is a plan view that shows a conventional etching resist pattern, and a wiring pattern that has been formed.

FIG. 10 is a schematic view of a wiring pattern according to Conventional Technology 1.

FIG. 11 is a front view of a printed wiring board according to Conventional Technology 2.

FIG. 12 is a front view of a printed wiring board according to Conventional Technology 3.

### DESCRIPTION OF THE PREFERRED EMBODIMENTS

Hereinafter, embodiments of the present invention will be described with reference to the accompanying drawings.

### Embodiment 1

First, the fabrication method for a printed wiring board according to an embodiment of the present invention will be described.

A substrate of a printed wiring board is constituted from insulating resin such as, for example, glass epoxy resin or paper phenol resin. On the surface of the substrate, metal foil, for example copper foil, is formed. Next, a dry film photoresist is applied on the metal foil, a photomask is overlaid, and by irradiating ultraviolet rays, an etching resist is formed. Next, a portion that is not covered by the etching resist is etched by an etching solution. Afterward, a wiring pattern is formed by removing the etching resist, completing the printed wiring board.

The wiring pattern is configured from a circuit pattern that constitutes an electric circuit and a dummy pattern that is not necessary in order to constitute an electric circuit. The circuit pattern, for example, is configured from a land connected to a terminal of a semiconductor or the like, a terminal that is connected to a terminal of another electronic component, and a conducting wire that connects the land and the terminal.

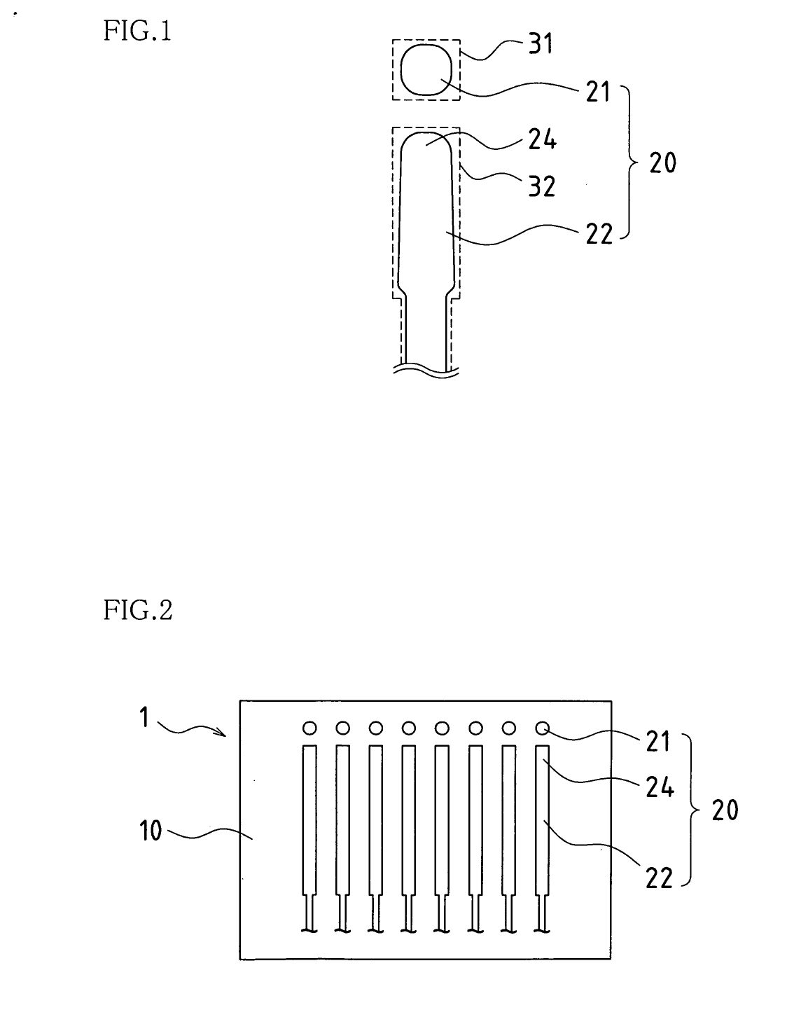

Next is a description of a wiring pattern formed by etching. FIG. 1 is a schematic view in which examples of a terminal, a dummy pattern, and a resist pattern that corresponds to the terminal and the dummy pattern are shown enlarged. In FIG. 1, the solid lines indicate a terminal 22 and a dummy pattern 21. The broken lines indicate resist patterns 31 and 32 provided in order to form the dummy pattern 21 and the terminal 22.

The dummy pattern 21 is formed isolated in the vicinity of the circuit pattern. In particular, the dummy pattern 21 is formed in the vicinity of a portion where it is anticipated that there will be much side etching compared to other portions. In FIG. 1, because the rate at which side etching advances is higher for an end 24 of the terminal 22 with a rectangular terminal shape than for other portions of the terminal 22, the dummy pattern 21 is formed on a line extended from the end 24.

The terminal 22 and the dummy pattern 21 formed in this manner are smaller overall than the resist patterns 31 and 32. The end 24 of the terminal 22 also has about the same amount of side etching as the other portions of the terminal 22, so the rate of etching advancement is suppressed. The reason for this is that due to the dummy pattern 21 being present in the vicinity of the end 24 of the terminal 22, the etching solution in this vicinity etches both the dummy pattern 21 and the terminal 22, and the speed of etching advancement for the end 24 is mitigated by lowering the concentration of the etching solution, suppressing side etching of the end 24.

Also, the dummy pattern 21 disposed in the vicinity of the end 24 obstructs the flow of the etching solution, the frequency of turnover of the etching solution is lowered and inflow of new etching solution is reduced, and activity of the etching solution decreases, so that side etching of the end 24 is suppressed.

Because the circuit pattern is etched by side etching, the resist patterns 31 and 32 are designed somewhat large in consideration of the amount of side etching.

Next is a description of modifications of the etching conditions. The wiring pattern is formed in an appropriate shape by adjusting the etching conditions. The etching conditions can be modified by, for example, the concentration, the temperature, or the flow quantity of the etching solution.

The etching state is known by measuring the amount of etching of the dummy pattern 21. Also, because the dummy pattern 21 is disposed in the vicinity of the circuit pattern for which excessive side etching is anticipated, the dummy pattern 21 becomes an indicator for knowing the etching state in the vicinity. It is also possible to provide the dummy pattern 21 at a plurality of locations on the printed wiring board, so it is possible to monitor the etching state of the circuit pattern at a plurality of locations at the same time.

Further, because the dummy pattern 21 is separated from the circuit pattern, it is possible to easily compare the area of the resist for the dummy pattern 21 to the area of the dummy pattern 21, so that the amount of etching can be easily measured. Thus, the rate at which etching advances can easily be known. Also, the rate at which etching advances can be judged visually.

For example, when the area of the dummy pattern 21 is not more than half of the area of the etching resist for the dummy pattern 21, it is preferable to adopt processing that decreases the flow quantity of the etching solution, or processing that decreases the temperature of the etching solution. Also, a configuration may be adopted in which the etching conditions are not modified by measuring the amount of etching in the dummy pattern 21 with this form, but by measuring the amount of etching in the circuit pattern.

Next is a description of an example of a wiring pattern in the present embodiment.

FIG. 2 is a plan view that shows an example of a wiring pattern of the printed wiring board in Embodiment 1. A wiring pattern 20 is formed on the surface of a substrate 10 of a printed wiring board 1. In this example, an approximately circular dummy pattern 21 is formed for each terminal 22 on a line extended from the terminal 22 as a parallel circuit pattern. The end 24 of the terminal 22 is at the end of the circuit pattern, and is a portion with a fast rate of etching advancement, so side etching is suppressed by providing the dummy pattern 21.

Also, a dummy pattern 21 is disposed at a constant distance relative to each terminal 22. Thus, parallel terminals 22 are formed with approximately the same size and shape by etching with the same conditions.

FIG. 2 shows an example in which the dummy patterns 21 remain after the circuit patterns have been formed, but a configuration may also be adopted such that the dummy patterns 21 are completely removed. In this case, unnecessary dummy patterns 21 are eliminated when designing the electric circuit, so packaging mistakes do not occur. That is, when a dummy pattern 21 remains, there is a risk that a terminal 22 of an electronic component or the like will be disposed on a dummy pattern 21 due to a packaging mistake, but here packaging is finished without producing a packaging mistake.

Also, in this embodiment, the dummy patterns 21 are formed in an approximately circular shape, but the present invention is not limited to a configuration in which the dummy patterns 21 are circular. For example, the dummy patterns 21 may be formed in an oval, rectangular, or triangular shape. Thus, according to the position, shape, and the like of the circuit patterns that suppress side etching, the dummy patterns 21 can be disposed with an appropriately modified shape, so that the amount of etching is controlled according to the respective portions, and as a whole an optimum circuit pattern can be created.

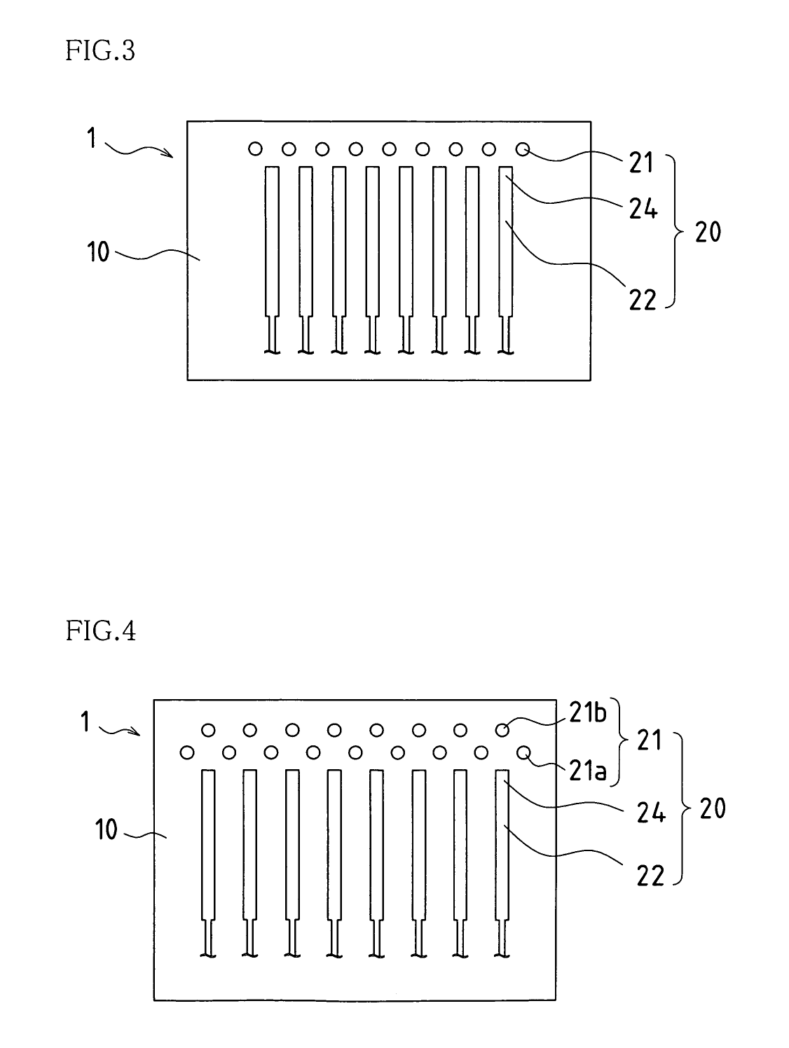

FIG. 3 is a plan view that shows another example of a wiring pattern of the printed wiring board in Embodiment 1. The wiring pattern 20 is formed on the surface of the substrate 10 of the printed wiring board 1. In this example, an approximately circular dummy pattern 21 is formed corresponding to each terminal 22 on both sides of a line extended from the terminal 22 as a parallel circuit pattern. The dummy pattern 21 does not hinder the flow of the etching solution that passes both sides of the end 24 of the terminal 22 that is a circuit pattern, so that the flow, activity, temperature, and concentration of the etching solution are controlled, and it is possible to control side etching in the end 24 of the terminal 22.

Also, FIG. 4 is a plan view that shows still another example of a wiring pattern of the printed wiring board in Embodiment 1. The wiring pattern 20 is formed on the surface of the substrate 10 of the printed wiring board 1. In this example, on both sides of a line extended from the terminal 22 as a parallel circuit pattern, approximately circular dummy patterns 21 (first dummy patterns 21a) are formed arranged in a line for each terminal 22, and moreover, other dummy patterns 21 (second dummy patterns 21b) are disposed behind the first dummy patterns 21a (the side opposite to the side where the terminals 22 are arranged), each offset about half the distance of the gap between dummy patterns 21. Thus, the total area of these dummy patterns 21 increases, and because the flow of the etching solution is very much hindered, the amount of side etching of the terminals 22 is more effectively controlled.

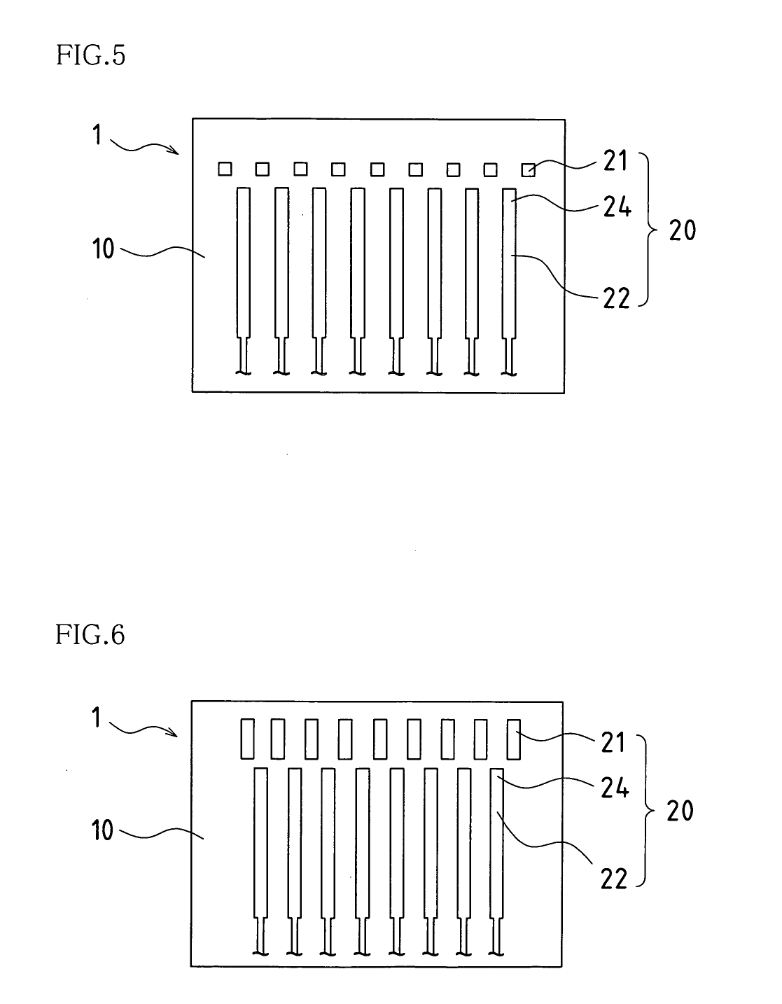

FIG. 5 is a plan view that shows still another example of a wiring pattern of the printed wiring board in Embodiment 1. The wiring pattern 20 is formed on the surface of the substrate 10 of the printed wiring board 1. In this example, on both sides of a line extended from the terminal 22 as a parallel circuit pattern, approximately square dummy patterns 21 are formed corresponding to each terminal 22. Because the dummy patterns 21 are approximately square and not streamlined, it is possible to hinder the flow of the etching solution on both sides of the ends 24 of the terminals 22 that are circuit patterns, and side etching in the ends 24 of the terminals 22 can be more effectively controlled.

FIG. 6 is a plan view that shows still another example of a wiring pattern of the printed wiring board in Embodiment 1. Same as in the above embodiments, the wiring pattern 20 is formed on the surface of the substrate 10 of the printed wiring board 1, but in this example, the dummy patterns 21 that correspond to the respective parallel terminals 22 are formed in an approximately rectangular shape. These dummy patterns 21 are formed lengthwise as rectangles on both sides of a line extended from the terminals 22 as circuit patterns, and can effectively hinder the flow of the etching solution that passes on both sides of the end 24 of the terminal 22. Accordingly, it is possible to more effectively control side etching in the end 24 of the terminal 22.

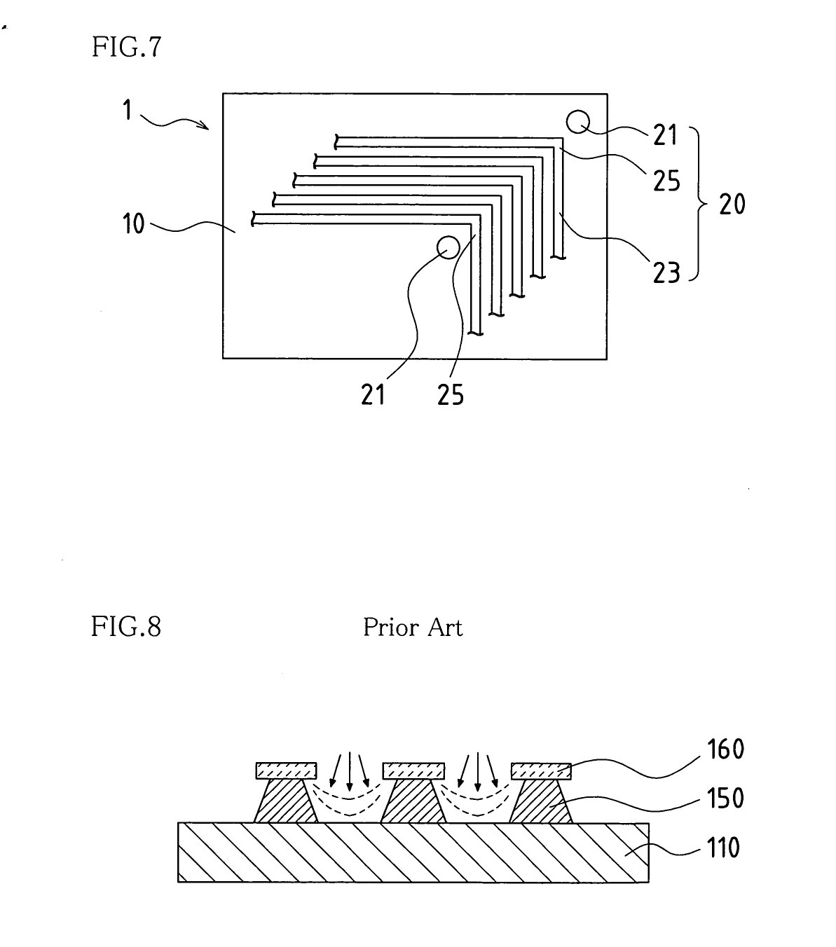

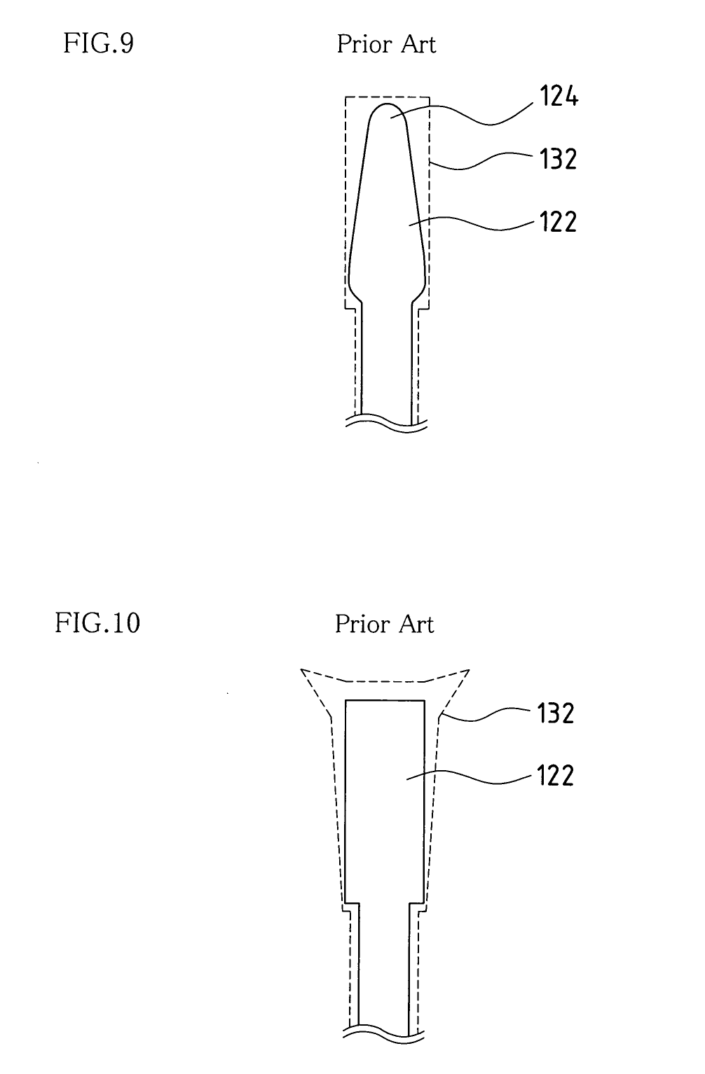

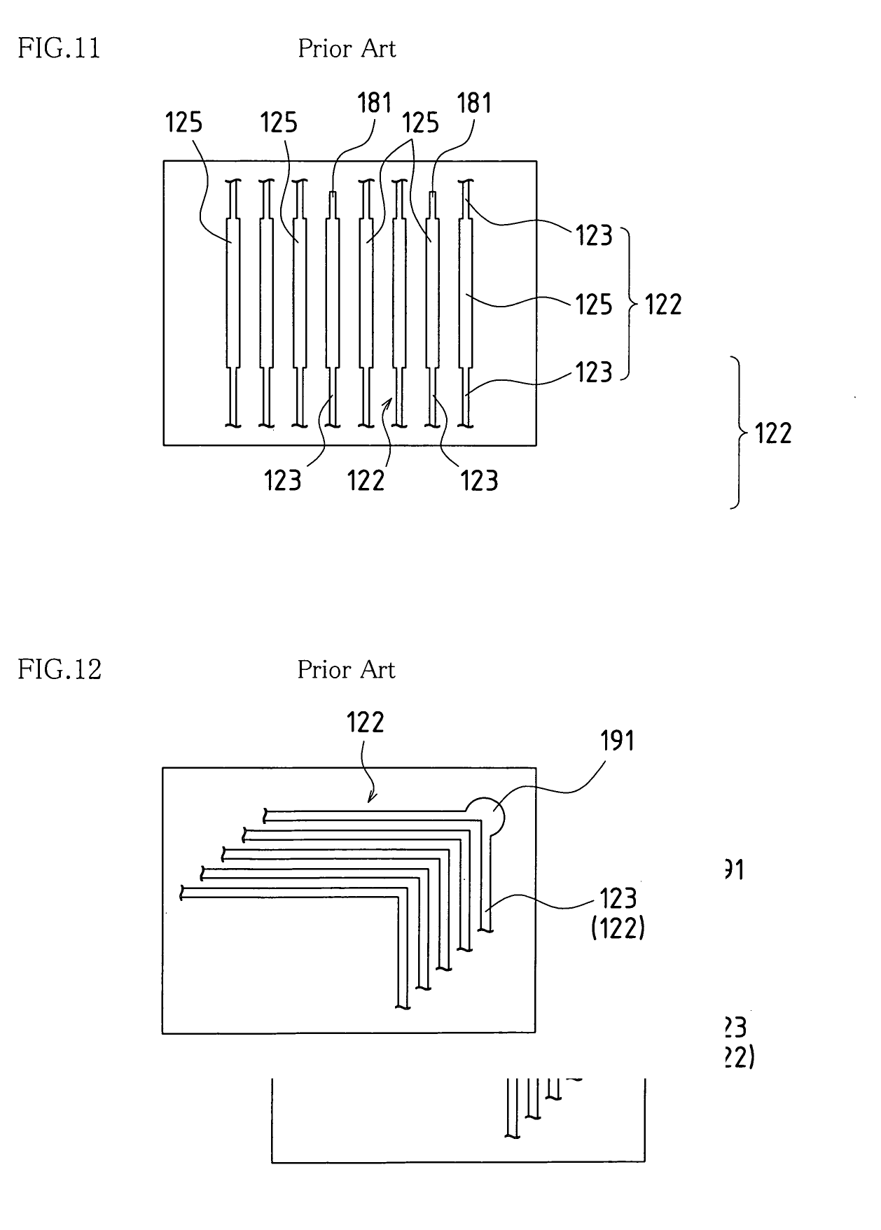

FIG. 7 is a plan view that shows still another example of a wiring pattern of the printed wiring board in Embodiment 1. In this printed wiring board 1, the wiring pattern 20 is formed on the surface of the substrate 10, and dummy patterns 21 are formed in the vicinity of bend portions 25 of conducting lines 23 as circuit patterns. The bend portions 25, which are bent at a right angle, are portions where etching is particularly likely to occur, and so by providing dummy patterns 21 in their vicinity, it is possible to effectively suppress side etching.

In the present invention, the providing of such dummy patterns 21 can be applied in any sort of case if they are provided in the vicinity of the angled portion of the circuit pattern. For example, if as described above the circuit pattern is not in a line (conducting line 23), that is, if the circuit pattern is a land on which an electronic component is mounted, dummy patterns 21 may be provided in the vicinity of an angled portion of this land, similar to the disposed form as given for example in FIG. 7, and in this case as well it is possible to effectively control side etching.

### Embodiment 2

Next is a description of a photomask for the printed wiring board according to the present invention, with reference to FIGS. 1 to 7.

In the photomask, a mask pattern for forming the wiring pattern 20 is formed. As described in Embodiment 1, the wiring pattern 20 is configured from a circuit pattern that constitutes an electric circuit, and the dummy pattern 21, which is not necessary in order to constitute the electric circuit. On the other hand, the mask pattern is configured from a circuit mask pattern and a dummy mask pattern that correspond to the circuit pattern and the dummy pattern 21.

When fabricating the printed wiring board 1, by using this sort of photomask, a photoresist that corresponds to the circuit pattern and the dummy pattern 21 is formed, and it is possible to create the printed wiring board 1 having the circuit pattern and the dummy pattern 21.

### Embodiment 3

Next is a description of the photomask creation program according to the present invention, with reference to FIGS. 1 to 7.

The photomask creation program is configured from a circuit module that forms a circuit mask pattern from a circuit pattern that constitutes an electric circuit, a dummy module that forms a dummy mask pattern that corresponds to the dummy pattern 21, and a combining portion that combines the circuit mask pattern and the dummy mask pattern.

The circuit module creates a circuit mask pattern for a circuit pattern that is input to the photomask creation program.

The dummy module designs positions at which it is possible to dispose dummy patterns 21, the shape of the dummy pattern 21, and the like based on the circuit pattern that is input to the photomask creation program, and creates a corresponding dummy mask pattern based on the designed dummy mask pattern 21.

Also, the circuit mask pattern and the dummy mask pattern are combined in the combining portion, creating the mask pattern.

With this sort of program, because it is possible to create a mask pattern that corresponds to the circuit pattern and the dummy pattern 21, a corresponding photomask can easily be created.

The present invention may be embodied in various other forms without departing from the gist or essential characteristics thereof The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. A fabrication method for a printed wiring board comprising:
forming an etching resist on metal foil that has been layered on an insulating resin board and performing etching via the etching resist, thus forming a wiring pattern, wherein
the wiring pattern is provided with a circuit pattern comprising an electronic circuit and a dummy pattern provided in the vicinity of and separated from the circuit pattern.

2. The fabrication method for a printed wiring board according to claim 1, wherein the dummy pattern is completely removed by etching.

3. The fabrication method for a printed wiring board according to claim 1, wherein the dummy pattern is partially removed by etching.

4. The fabrication method for a printed wiring board according to claim 1, wherein etching conditions for the etching are modified according to the amount of etching of the dummy pattern.

5. The fabrication method for a printed wiring board according to claim 1, wherein the dummy pattern is formed on a line extended from an end of the circuit pattern.

6. The fabrication method for a printed wiring board according to claim 1, wherein the dummy pattern is formed on both sides of a line extended from the end of the circuit pattern.

7. The fabrication method for a printed wiring board according to claim 5, wherein the circuit pattern is formed with a rectangular terminal shape.

8. The fabrication method for a printed wiring board according to claim 5, wherein ends of the circuit pattern are disposed in parallel, and dummy patterns are disposed in parallel corresponding to each end of a circuit pattern.

9. The fabrication method for a printed wiring board according to claim 8, wherein the dummy patterns are formed and disposed lined up in a plurality of lines.

10. The fabrication method for a printed wiring board according to claim 9, wherein the dummy patterns formed in a plurality of lines are formed and disposed with each of the plurality of lines offset relative to one another in the direction in which they are lined up.

11. The fabrication method for a printed wiring board according to claim 1, wherein the dummy pattern is formed in the vicinity of an angled portion included in the circuit pattern.

12. The fabrication method for a printed wiring board according to claim 1 1, wherein the angled portion is a bent portion of the circuit pattern.

13. The fabrication method for a printed wiring board according to claim 1, wherein the dummy pattern has a circular, oval, rectangular, or triangular shape.

14. A photomask for a printed wiring board for forming an etching resist that corresponds to a wiring pattern on metal foil that has been layered on an insulating resin board, wherein the wiring pattern is provided with a circuit pattern constituting an electronic circuit and a dummy pattern provided in the vicinity of and separated from the circuit pattern.

15. A photomask creation program that creates a mask pattern of a photomask for forming a photoresist that corresponds to a wiring pattern of a printed wiring board, wherein the wiring pattern is provided with a circuit pattern constituting an electronic circuit and a dummy pattern provided in the vicinity of and separated from the circuit pattern.

16. The fabrication method for a printed wiring board according to claim 6, wherein the circuit pattern is formed with a rectangular terminal shape.

17. The fabrication method for a printed wiring board according to claim 6, wherein ends of the circuit pattern are disposed in parallel, and dummy patterns are disposed in parallel corresponding to each end of a circuit pattern.
